(19) United States
(12) Patent Application Publication
(10) Pub. No.: US 2008/0297731 A1
(43) Pub. Date: Dec. 4, 2008

(54) APPARENT SPECKLE REDUCTION APPARATUS AND METHOD FOR MEMS LASER PROJECTION SYSTEM

(75) Inventors: Karlton D. Powell, Lake Stevens, WA (US); Margaret K. Brown, Seattle, WA (US); Bin Xue, Mukilteo, WA (US); Thomas W. Montague, Mercer Island, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 11/757,226

(22) Filed: Jun. 1, 2007

(51) Int. Cl. G03B 21/26; G03B 21/28

(52) U.S. Cl. 353/37

(57) ABSTRACT

A laser projection system is disclosed having reduced apparent speckle. The system includes a laser emitting a first beam on an optical element. The optical element emits a second beam incident on a scanner that scans the beam onto a projection screen. The optical element may be an exit pupil expander, delay plate, or have a locally electrically modulated index of refraction. In other embodiments, the laser has a tunable wavelength distribution that is changed for each frame displayed by the projection system to reduce apparent speckle. In still other embodiments, the angular content of a beam incident on a scanner is modulated to produce a time varying speckle pattern.

### TECHNICAL FIELD

This invention relates to scanning imaging systems and more particularly to laser scanning imaging systems.

### BACKGROUND OF THE INVENTION

In some scanned laser projection systems, a laser beam is directed at an actuated scanner that directs the beam across a projection screen. As the beam is scanned, the intensity of the laser is modulated to create light and dark areas on the projection screen to form an image. A typical projection screen will have an irregular surface that scatters the beam. As a result, portions of the beam reflected from different irregularities may be phase shifted relative to one another. Due to the coherence of the beam, if the phase shift is less than the coherence length, portions of the reflected beam will constructively and destructively interfere to form a pattern of dark and light regions often referred to as speckle. The presence of speckle often perceptibly degrades the quality of the image produced using the laser projection system.

Prior attempts to reduce speckle have been bulky and ill-suited for use in a Micro-Electro-Mechanical System (MEMS) scanner context. In view of the foregoing it would be an advancement in the art to provide a compact apparatus suitable for reducing speckle in a MEMS laser projection system.

### SUMMARY OF THE INVENTION

In one aspect of the invention, an imaging system includes a coherent light source emitting a first beam. A scanner including a mirror is positioned an optical distance from the coherent light source. The mirror may have a width greater than an expected width of the first beam projected the optical distance from the coherent light source. An optical element is interposed between the scanner and coherent light source. The optical element receives the first beam and emits a second beam onto the mirror. The second beam may have a numerical aperture substantially larger than the first beam.

In another aspect of the invention, the second beam includes multiple beams that may overlap and be arranged in an ordered array. The multiple beams may be mutually incoherent to one another in embodiments where the optical element is a delay plate having multiple optical paths of differing lengths. In other embodiments, the optical element is an exit pupil expander (EPE) and the second beam includes multiple diffraction orders of the first beam which are mutually coherent with other beamlets within second beam. The EPE may be positioned at the focal plane of the first beam between the scanner and a projection lens, enabling projection of an intermediate scanned image from the EPE plane onto the projection screen.

In another aspect of the invention, the optical element has a locally electrically modulated index of refraction. The optical element is coupled to one or more drive circuits programmed to exert one or more time-varying voltage signals on the optical element. In such embodiments, the optical element may be embodied as a lithium niobium oxide (LiNbO₃) wafer.

In another aspect of the invention a coherent light source emits a first beam having a first wavelength distribution as the scanner scans a first image on a projection screen. The laser is then tuned to a second wavelength distribution and the scanner scans a second image on the projection screen. In such embodiments, the laser may be embodied as a tunable distributed Bragg reflector (DBR) laser.

In another aspect of the invention, an optical element such as an optical fiber, electro-optic angular deflector, liquid crystal lens, or liquid crystal aperture is positioned between a coherent light source and a scanner to modulate the angle of incidence of a beam on the scanner in order to produce a time varying speckle pattern.

### BRIEF DESCRIPTION OF THE DRAWINGS

FIG. 1 is a schematic illustration of a laser projection system having a delay plate for performing speckle reduction in accordance with an embodiment of the present invention.

FIG. 2 is a front elevation view of a delay plate in accordance with an embodiment of the present invention.

FIG. 3 is a schematic illustration of an alternative embodiment of a laser projection system having a delay plate for performing speckle reduction in accordance with an embodiment of the present invention.

FIG. 4 is a schematic illustration of an overlapping beam pattern such as may be produced by the laser projection system of FIG. 3 in accordance with an embodiment of the present invention.

FIG. 5 is a schematic illustration of a laser projection system having a folding guide for performing speckle reduction in accordance with an embodiment of the present invention.

FIG. 6A is a schematic illustration of a laser projection system having multiple lasers incident on an augmented scanner for performing speckle reduction in accordance with an embodiment of the present invention.

FIG. 6B is a schematic illustration of a laser projection system having multiple lasers and scanners for performing speckle reduction in accordance with an embodiment of the present invention.

FIG. 7 is a schematic illustration of a laser projection system having a converter element located at a focal plane of a laser beam for performing speckle reduction in accordance with an embodiment of the present invention.

FIG. 8 is a schematic illustration of a laser projection system having a scanner positioned between a light source and a converter element for performing speckle reduction in accordance with an embodiment of the present invention.

FIG. 9 is a schematic illustration of a laser projection system having a multiple spatial mode light source for performing speckle reduction in accordance with an embodiment of the present invention.

FIG. 10 is a schematic illustration of a laser projection system having a multi lens array interposed between a scanner and a screen for performing speckle reduction in accordance with an embodiment of the present invention.

FIG. 11 is a schematic illustration of a dual multi lens array suitable for use in the embodiment of FIG. 10 in accordance with an embodiment of the present invention.

FIG. 12 is a schematic illustration of a laser projection system having a wave front modulating element for producing time-varying locally phase-shifted regions for reducing speckle in accordance with an embodiment of the present invention.

FIG. 13 is an isometric view of a wave front modulating element for performing speckle reduction in accordance with an embodiment of the present invention.

FIG. 14 is a top plan view of a wave front modulating element for performing speckle reduction in accordance with an embodiment of the present invention.

FIG. 15 is a schematic block diagram of a system for driving the wave front modulating element of FIGS. 12-13 to perform speckle reduction in accordance with an embodiment of the present invention.

FIG. 16 is a schematic block diagram of a an alternative system for driving the wave front modulating element of FIGS. 12-13 to perform speckle reduction in accordance with an embodiment of the present invention.

FIG. 17 is an isometric view of an alternative embodiment of a wave front modulating element for performing speckle reduction in accordance with an embodiment of the present invention.

FIG. 18 is a schematic illustration of a laser projection system performing wavelength modulation for performing speckle reduction in accordance with an embodiment of the present invention.

FIG. 19 is a process flow diagram of a method for performing wavelength modulation to reduce speckle in accordance with an embodiment of the present invention.

FIG. 20 is a graphical representation of wavelength modulation for reducing speckle in accordance with an embodiment of the present invention.

FIG. 21 is a schematic illustration of a scanning pattern in a laser projection system in accordance with an embodiment of the present invention.

FIG. 22 is a schematic illustration of a laser projection system having an actuated diffractive optical element for performing speckle reduction in accordance with an embodiment of the present invention.

FIG. 23 is a top plan view of a comb drive bearing a diffraction grating for performing speckle reduction in accordance with an embodiment of the present invention.

FIG. 24 is a schematic illustration of a laser projection system having electro-optic angular deflectors for reducing speckle in accordance with an embodiment of the present invention.

FIGS. 25A and 25B are schematic illustrations of laser projection systems having a liquid crystal lens for reducing speckle in accordance with an embodiment of the present invention.

FIG. 26 is a schematic illustration of a laser projection system having an actuated optical fiber for reducing speckle in accordance with an embodiment of the present invention.

FIG. 27 is a schematic illustration of an alternative embodiment of a laser projection system having an actuated optical fiber for reducing speckle in accordance with an embodiment of the present invention.

FIG. 28 is a schematic illustration of an alternative embodiment of a laser projection system having a variable aperture for reducing speckle in accordance with an embodiment of the present invention.

FIG. 29 is a schematic block diagram of a device incorporated a projector implementing speckle reduction apparatus and methods in accordance with an embodiment of the present invention.

### DETAILED DESCRIPTION OF PREFERRED EMBODIMENTS

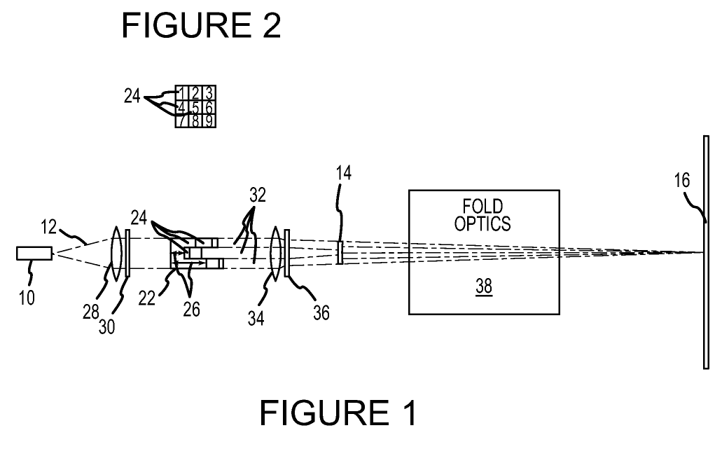

Referring to FIGS. 1 and 2, in some embodiments, speckle reduction is achieved by increasing the angular diversity of light incident on the screen 16. For example, in the embodiment of FIGS. 1 and 2, a laser 10 produces a beam 12 that is directed through a delay plate 22 having discrete regions 24. The laser 10 may have a Gaussian, top-hat, or other intensity and/or wavelength distribution. The discrete regions 24 may have different optical path lengths. Different optical path lengths may be achieved by varying the physical lengths 26 of the discrete regions 24 or by constructing the discrete regions of materials having different indices of refraction. In some embodiments, both the lengths 26 and the indices of refraction differ. The discrete regions 24 may each be square shaped, as illustrated in FIG. 2, or may be hexagonally shaped in order to form a more compact delay plate 22. Each of the discrete regions 24 may have an optical path length differing from the optical path lengths of one, more than one, or all, of the other discrete regions 24 by an amount greater than the coherence length of the laser 10.

For certain diode lasers, the fringe visibility can vary with optical pathlength, exhibiting multiple peaks that diminish as the optical path difference increases. Thus optical path differences may be aligned to low contrast troughs between peaks in order to reduce the thickness of the delay plate 22 relative to a delay plate 22 providing optical path differences greater than the range of optical path differences at which peaks occur.

In some embodiments, the beam 12 passes through a lens 28 and/or an aperture 30 prior to passing through the delay plate 22. The beamlets 32 exiting the delay plate 22 may also pass through a lens 34 and/or an aperture 36 prior to reflecting off the scanner 14. In some embodiments, fold optics 38 are positioned between the scanner 14 and the screen 16 to reduce the size of the imaging system.

The beamlets 32 exiting the delay plate 22 are preferably mutually incoherent due to the differing delays within the delay plate 22. The cone numerical apertures (NAs) of the beamlets 32 may overlap on the screen 16 such that the speckle patterns of the beamlets 32 overlap. As the speckle patterns overlap, differences in the phases and angles of incidence of the beamlets 32 cause the speckle patterns of the beamlets to differ from one another, resulting in a combined speckle pattern in which the contrast caused by speckle is reduced. The combined speckle pattern therefore has a reduced as apparent speckle as compared to an individual beamlet 32.

In some embodiments, the size of the combined cone NAs of the beamlets 32 is substantially larger than the cone NA of the original beam 12, which may be a diffraction-limited cone NA. Furthermore, because the beamlets 32 are out of phase with one another, the smallest spot size to which the combined beamlets 32 may be focused may be limited. The scanner 14 may therefore have a combined scan angle and mirror diameter (OD value) larger than the OD value needed to scan the diffraction limited cone NA of beam 12 to create an image at a given resolution. For example, the OD value may be 2 to 10 times larger than needed to scan substantially all of the light of the original beam 12. In an alternative embodiment, the OD value may be 4 to 8 times larger than needed to scan substantially all of the light of the original beam 12.

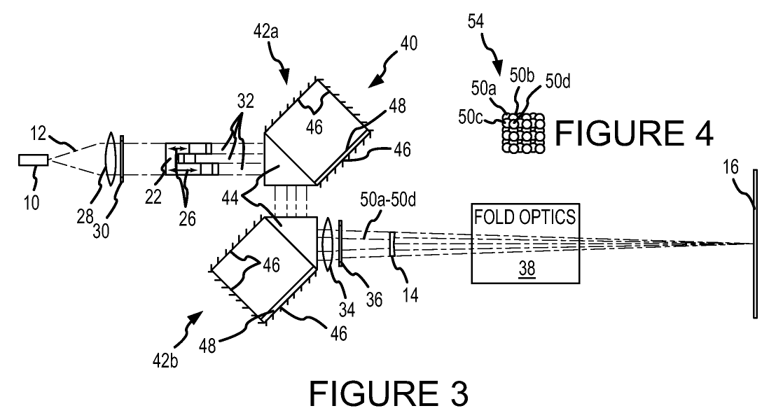

Referring to FIGS. 3 and 4, in an alternative embodiment, a multimode element 40 is interposed between the delay plate 22 and the scanner 14. The multimode element 40 preferably provides for each beamlet 32 to be divided such that portions of the light of each beamlet 32 travel different paths and exit from the multimode element 40 spatially offset and/or phase shifted from one another. In the illustrated embodiment, the multimode element 40 is one or more delay blocks 42a, 42b comprising a triangular prism 44 on one face and reflective surfaces 46 on the interior surface of the other faces. The surfaces 46 may be of equal or different lengths such that they form a cubic or rectangular prism. A beam splitter 48 may be positioned adjacent one of the reflective surfaces 46 in order to divide the beamlets 32. The beam splitter 48 may have a different index of refraction than the remainder of the delay block 42a, 42b.

The beamlets 32 incident on the beam splitter 48 are divided into multiple overlapping cone NAs 50a, 50b, shown in FIG. 4, such that the optical path length experienced by light transmitted through the beam splitter 32 is greater than that of light reflected from the beam splitter 32. As a result of the different optical paths within the delay blocks 42a, 42b, the beamlets 32 are further divided into multiple cone NAs 50a-50d emerging from the multimode element 40 offset from one another perpendicular to the direction of propagation. The differences in the optical path lengths of the cone NAs 50a, 50b may also result in a change in the relative phase of the cone NAs 50a-50d, which serves to further increase the speckle density at the screen and therefore reduce the visible effect of the speckle pattern. A mirror may be positioned between the multimode element 40 and the scanner 14 to direct the cone NAs 50a, 50b at the scanner 14.

Referring specifically to FIG. 4, upon exiting the multimode element 40, the beamlets cone NAs 50a-50d may have a spot pattern 54 as illustrated wherein each beamlet 32 is divided into multiple overlapping cone NAs 50a-50d. Where two delay cubes 42 are used, each beamlet 32 may be divided into four or more overlapping cone NAs 50a, 50b. Although in the illustrated embodiment, a 3×3 array of beamlets 32 is used, larger arrays may be beneficial. For example a 5×5 array may provide greater speckle reduction. Where two delay cubes 42 are used, the beamlets 32 may be replicated on two orthogonal axes by proper orientation of the cubes (e.g. by rotating one of the delay cubes 42 ninety degrees about an axis 55 and redirecting the beams 32 to be incident on a face of the prism 44).

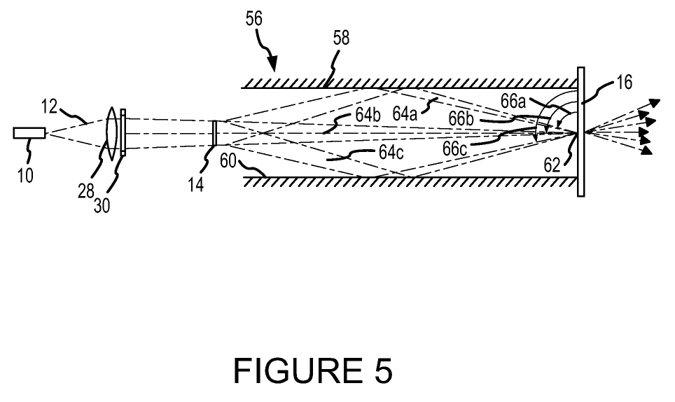

Referring to FIG. 5, in another embodiment, a folding guide 56 is used to direct the beam 12 at a screen 16 such that multiple speckle patterns are produced. The scanner 14 scans the beam 12 across a first mirror 58 of the folding guide, across the screen 16, and then across a second mirror 60 such that each pixel 62 is drawn by three beams 64a-64c each at a different angle of incidence 66a-66c. The different angles of incidence cause the beams 64a-64c to create different speckle patterns that overlap to produce a combined speckle pattern with a reduced speckle size. As a result, the visible effect of the combined speckle pattern is reduced. In the illustrated embodiment, three beams 64a-64c are generated, however in some embodiments more than three beams are generated by the folding guide 56. Inasmuch as the beams 64a-64c are scanned onto the screen 16 in sequence they are therefore not temporally coherent with one another. The different speckle patterns of the beams 64a-64c are time-averaged by a viewer's eye to reduce the visible effect of speckle.

In some embodiments, the intensity of the laser 10 is modulated to produce an image. In order to produce an image in the system of FIG. 5, the laser 12 may modulate the intensity of the laser 12 to draw a line of pixels multiple times. For example, a first line of pixels may be drawn while the beam 12 is incident on the upper mirror 58. The same line of pixels may be drawn in reverse order while the beam 12 is incident directly on the screen 16. The same line of pixels is drawn in the original order while the beam 12 is incident on the lower mirror 50. The modulation of the intensity of the laser 10 may be registered with respect to the movement of the scanner 14 such that the pixels scanned by different beams 64a-64c align with one another to create the same image.

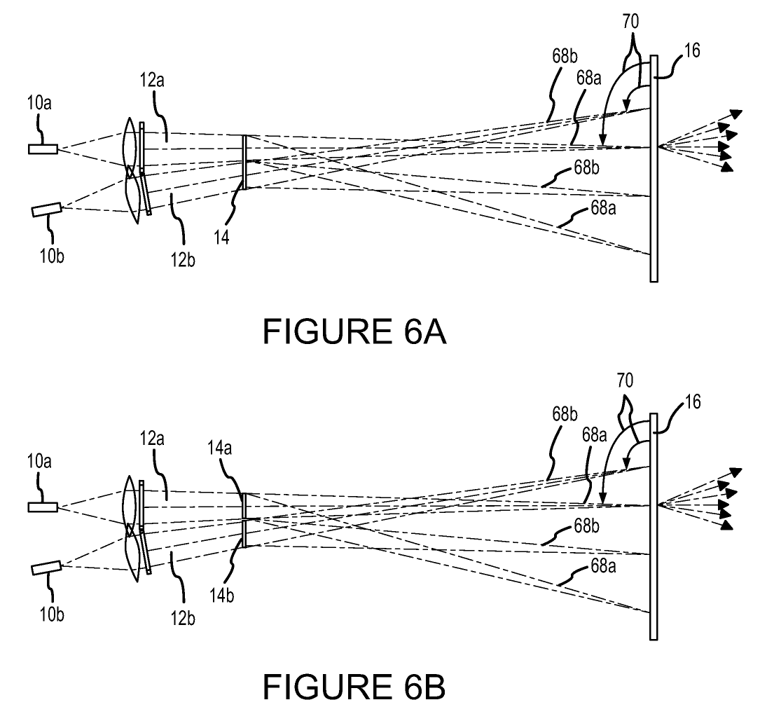

Referring to FIG. 6, in an alternative embodiment, multiple lasers 10a, 10b direct beams 12a, 12b at the scanner 14. The scanner 14 of FIG. 6 preferably has a OD value such that the beams 12 may be incident on different locations on the scanner 14 such that the beams 68a, 68b emitted from the scanner 14 will have different angles of incidence 70 on a given point on the screen 16. For example, the OD value may be 2 to 10 times larger than needed to scan substantially all of the light of the original beam 12. In an alternative embodiment, the OD value may be 4 to 8 times larger than needed to scan substantially all of the light of the original beam 12.

The differing angles of incidence 70 will promote differing speckle patterns such that the combined speckle patterns of the beams 68a, 68b will reduce the amount of speckle apparent to a viewer. As is apparent in FIG. 6, the beams 68a, 68b scan different portions of the screen at different times. Accordingly, the intensity of each of the lasers 10a, 10b will preferably be modulated in registration with the scanner 14 such that the image created by the beams 68a, 68b are substantially aligned with one another to create a single image. Although two lasers 10a, 10b are shown in FIG. 6, in other embodiments three or more lasers are used.

As an alternative approach to the embodiment of FIG. 6, multiple scanners 14a, 14b each corresponding to one of the lasers 10a, 10b may be used to scan the beams 68a, 68b across the screen 16. Where multiple scanners 16 are used, the individual scanners 16 may preferably have a OD value equal or only slightly greater than sufficient to scan the diffraction limited cone NA of the beams 12a, 12b.

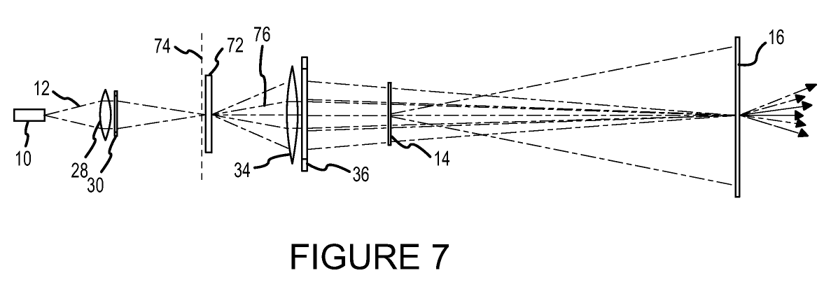

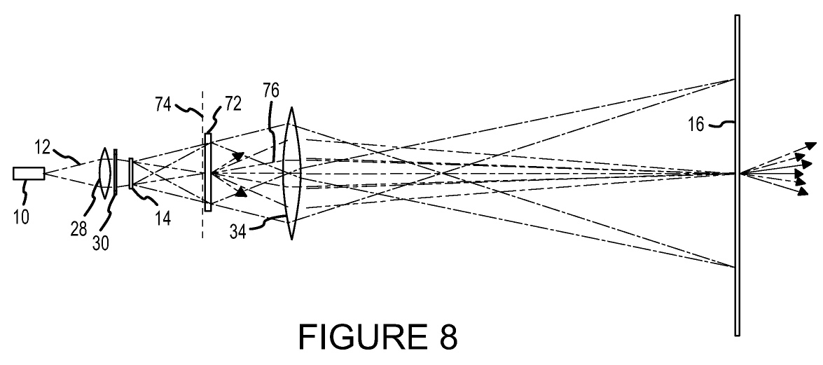

Referring to FIGS. 7 and 8, in an alternative embodiment, a laser 10 emits a beam 12 incident on a converter element 72. In the embodiment of FIG. 7, the converter element 72 is located optically between the laser 10 and the scanner 14. In the embodiment of FIG. 8, the scanner 14 is located optically between the laser 10 and the converter element 72. In one embodiment, the converter element 72 is located proximate a focal plane 74 of the lens 28. The converter element 72 emits a second beam 76 that may include multiple cone NAs, which may be diffraction-limited cone NAs. The combined size of the NAs constituting the beam 76 may be greater than that of the beam 12 entering the converter element 72.

In the embodiment of FIG. 7, the converter element 72 may be a one-dimensional element suitable for converting the first beam 12 into a second beam 76 including multiple diffraction orders of the first beam 12. In the embodiment of FIG. 8, the converter element 72 may advantageously be a two-dimensional array such that as the beam 12 is scanned across the converter element 72 each element within the array will emit a beam 76 comprising multiple diffraction orders of the beam 12. The elements in the two-dimensional array may have the same number of pixels and aspect ratio as images produced using the projection system. In some embodiments, the number of elements is greater than the number of pixels produced using the projection system.

The converter element 72 may randomize the beam 76, such as by means of a surface relief diffuser, scattering grain screen, volume hologram, volume hologram in combination with a scattering grain screen, or a multimode fiber. Where a multimode fiber is used for the converter element 72, the fiber may advantageously be sufficiently long and/or curved to fill a significant number of the modes of the fiber.

In other embodiments, the converter element 72 emits a beam 76 having a periodic arrangement of beamlets. In the embodiment of FIG. 8, the converter element 72 may a plurality of elements each emitting a periodic arrangement of beamlets. For example, the converter element 72 may be embodied as an exit pupil expander (EPE), periodic grating such as a multi-lens array (MLA), dual multi-lens array (DMLA), diffractive optical element (DOE), or holographic optical element (HOE). The converter element 72 may also be embodied as a phosphor screen conversion plane.

The scanner 14 of FIG. 7 may preferably have a OD value substantially larger than needed to scan the diffraction-limited cone NA of the beam 12. For example, the OD value may be 2 to 10 times larger than needed to scan substantially all of the light of the original beam 12. In an alternative embodiment, the OD value may be 4 to 8 times larger than needed to scan substantially all of the light of the original beam 12. The OD value is preferably sufficiently large to scan a significant portion or substantially all of the multiple cone NAs of the beam 76 onto the screen 16. In the embodiment of FIG. 8, the scanner 14 preferably has a OD value equal or only slightly larger than sufficient to scan substantially all of the light diffraction limited cone NA of the original beam 12. The aperture 36 through which the beam 76 passes is preferably sized such that multiple NAs are permitted to pass therethrough and create multiple speckle patterns on the screen 16. For the embodiment of FIG. 8, the aperture 36 may be omitted since clipping the beam will not affect scatter at the scanner.

The converter element 72 may advantageously produce a beam 76 comprising cone NAs that are different diffraction orders of the original beam and are coherent with one another. As a result, as the beam 76 is focused, interference between the multiple coherent cone NAs causes results in about the same spot size as the original beam 12. The maximum resolution of the imaging system may therefore not be substantially reduced by using a converter element 72, particularly in the Embodiment of FIG. 8. The thickness of the converter 72 may be chosen such that it is sufficiently thick to avoid excessive scattering of the beam 76 but sufficiently thin that the beam 76 is composed of cone NAs that are mutually coherent diffraction orders of the original beam 12.

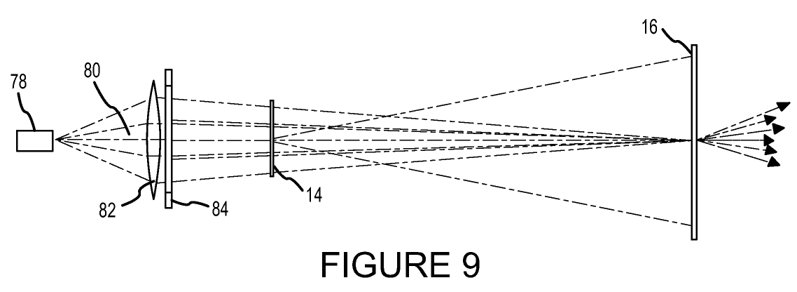

Referring to FIG. 9, in an alternative embodiment, a light source 78 having an extended spatial mode structure is used to scan the screen 16, rather than a more coherent light source such as a laser. The light source 78 preferably emits a beam 80 larger than a single diffraction limited cone NA. In some embodiments, the light source 78 has multiple spatial modes such that its M² value is much larger than one. The M² value indicates how closely the spatial frequency of a laser approximates a perfect Gaussian beam. The larger the M² value of a laser the greater the difference between the laser and a perfect Gaussian. The light source 78 may include an edge emitting light emitting diode (EELED), masked LED, or other incoherent source. The beam 80 may be focused by a lens 82 and passed through an aperture 84 prior to striking the scanner 14. The aperture 84 is preferably sufficiently large to permit multiple cone NAs to pass therethrough.

As with other embodiments of the invention, the scanner 14 of FIG. 9 may preferably have a ΘD value sufficiently large to scan a beam 80 having a size many times larger than a diffraction limited cone NA. For example, the ΘD value may be 2 to 10 times larger than needed to scan substantially all of the light of a diffraction limited cone NA of a beam having similar spectral content as the light source 78. In an alternative embodiment, the ΘD value may be 4 to 8 times larger than needed to scan substantially all of the light of a diffraction limited cone NA of a beam having similar spectral content as the light source 78. The different angles of incidence of the cone NAs composing beam 80 on the screen result in multiple overlapping speckle patterns that produce a combined speckle pattern having increased speckle density. The increased speckle density of the combined speckle pattern reduces the visible effect of the speckle pattern.

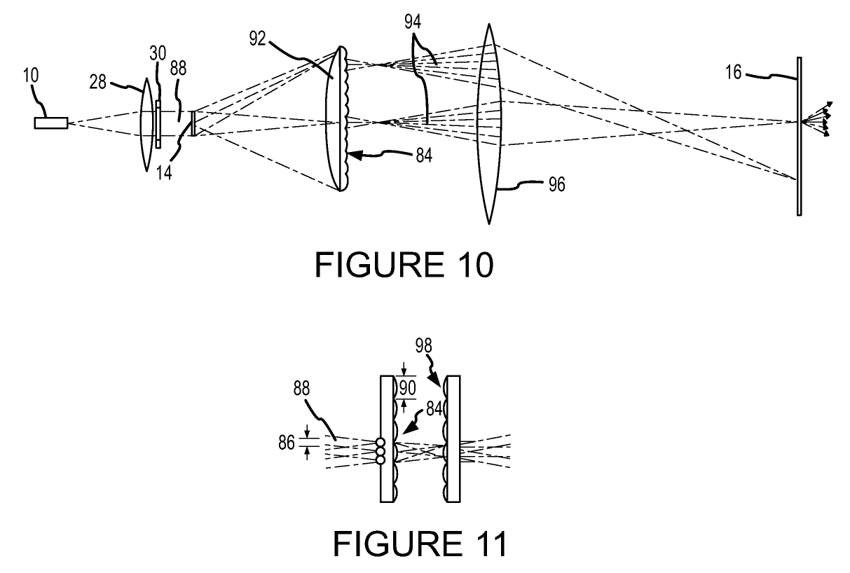

Referring to FIG. 10, in an alternative embodiment, a multi-lens array (MLA) 84 is positioned optically between the scanner 14 and the screen 16. The lens 28 may have a magnification chosen such that a spot size 86 of the beam 88 emitted from the lens 28 is substantially smaller than the pitch 90 of the MLA 84 at the entry plane of the MLA 84. For example, as shown in FIG. 11, the pitch 90 may be about equal to three times the spot size 86 of the beam 88 as it strikes the MLA 84. Scanning a beam 88 having a spot size 86 smaller than the pitch of the MLA 84 may beneficially provide an angularly diverse output from the MLA such that multiple overlapping speckle patterns are created and the amount of speckle apparent to a viewer is reduced.

The scanner 14 used preferably has a ΘD value sufficiently large to scan an image having a resolution that is many times greater than that of the MLA 84. In some embodiments the ΘD value of the scanner 14 is proportional to d_{MLA}/(M*S), where d_{MLA} is the pitch of the MLA 84, S is the spot size of the beam 12, and M is the magnification of the spot at the MLA 84, such as the magnification of the lens 28. The resolution of an image produced using the MLA 84 may be the resolution at an output plane of the MLA 84.

In some embodiments, a lens 92 may be located proximate the MLA 84 to provide telecentric correction of the beam 88. The beams 94 emitted from the lenses of the MLA 84 may be directed at a lens 96 that focuses the beams 94 onto the screen 16 to form an image. In some embodiments, the MLA 84 is part of a dual multi-lens array (DMLA), in such embodiments a second MLA 98 is used adjacent the MLA 84.

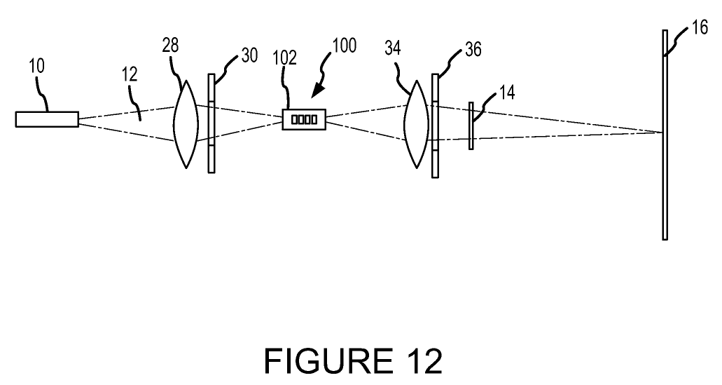

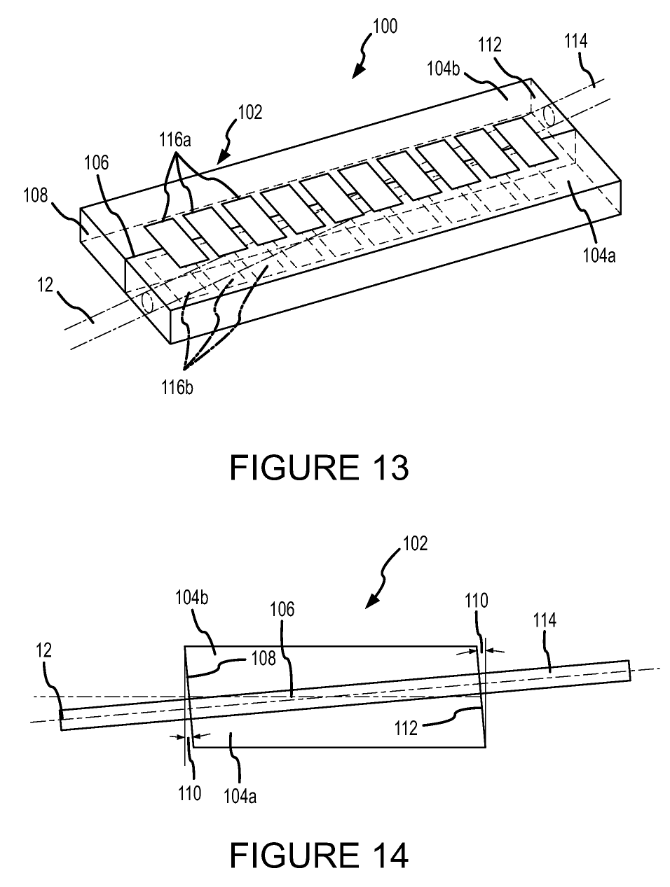

Referring to FIGS. 12 and 13, in an alternative embodiment, a wavefront modulating element 100 is interposed between the laser 10 and the scanner 14. In the illustrated embodiment, the wavefront modulating element 100 is a lithium niobate wafer (LiNbO₃) 102. The wafer 102 includes two regions 104a, 104b adjoining one another along a domain boundary 106. One of the regions 104a, 104b has an inversed domain whereas the other of the regions 104a, 104b is not. In the illustrated embodiment, the region 104b is domain inversed.

Referring to FIG. 14, while still referring to FIGS. 12 and 13, the beam 12 from the laser 10 is incident on a first face 108 of the wafer 102. The beam 12 is preferably substantially perpendicular to the first face 108 and is incident on the region 104b such that the beam 12 will cross the domain boundary 106 as it passes through the wafer 102. The first face 108 is at an angle 110 with respect to the domain boundary 106. In some embodiments, the angle 110 is between about four and six degrees. In a preferred embodiment, the angle 110 is about five degrees. A second face 112 opposite the first face 108 is substantially parallel to the first face 108. The wafer 102 emits a beam 114 from the second face 112 that is incident on the scanner 14.

One or more electrodes 116a secure to an upper surface 118a of the wafer 102 and one or more electrodes 116b secure to a lower surface 118b of the wafer 102. Each of the electrodes 116b may be located substantially opposite one of the electrodes 116a as illustrated. Some or all of the electrodes 116a, 116b extend across the domain boundary 106. The electrodes 116a, 116b may be formed directly onto the wafer by means of sputtering, chemical vapor deposition, or other manufacturing method. In other embodiments, the electrodes are formed on one or more printed circuit boards to which the wafer 102 is mounted.

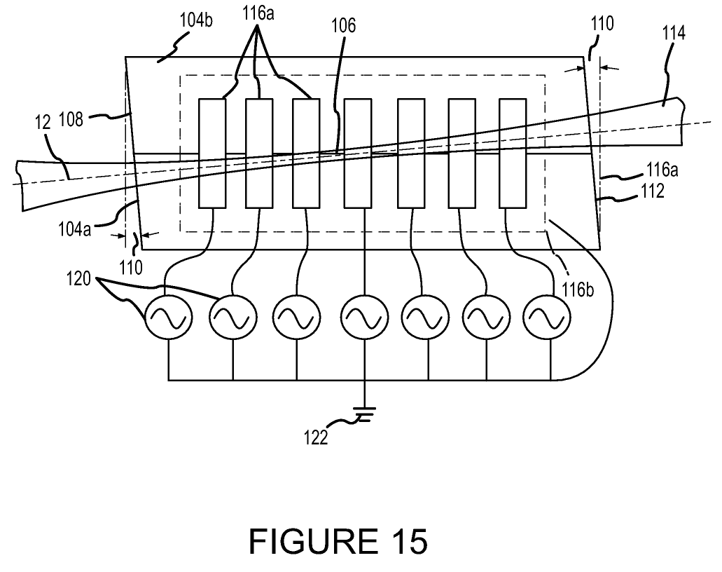

Referring to FIG. 15, one or more oscillators 120 induce voltages on the electrodes 116a. The lower electrodes 116b in the illustrated embodiment are electrically coupled to a reference voltage 122 such as ground. In some embodiments, the electrodes 116b are replaced with a single electrode 116b extending opposite all of the electrodes 116a.

The oscillators 120 induce local changes in the index of refraction of the wafer 102. As the beam 12 passes through the wafer 102, portions of the wavefronts cross the domain boundary 106 at different points. By modulating the index of refraction at the domain boundary 106, the optical path length that different portions of the wavefront pass through will differ from one another such that the wavefronts of the beam 114 emitted from the face 112 will have randomly (or periodically) distributed locally phase shifted regions. The pattern of locally phase shifted regions will vary with time due to the oscillating voltages applied to the electrodes 116a. As the wavefronts of the beam 114 reflect from the screen 16, the local timer-varying phase differences will create speckle patterns that vary more rapidly than the persistence of vision of the viewer's eye. As result, the visible effect of the speckle patterns will be reduced.

In some embodiments, the oscillators 120 cause the shape of the wavefronts of the beam 114 to vary with time at rate that exceeds a frame rate of the scanner 14. For example, the scanner may scan a complete image on the screen at a fixed rate. The frame rate may be between about 50 and about 80 Hz, preferably between about 50 and about 70 Hz, and more preferably about 60 Hz. The oscillators 120 may therefore vary the shape of the wavefronts at an equal or greater rate, such as greater than two times the frame rate, preferably between three and ten times the frame rate. The scanner may also be operated to scan pixels onto the screen at a rate that is equal to the frame rate multiplied by the number of pixels in the image, such as 307,200 (640×480), 480,000 (800×600), 786,432 (1024×768), or 1,310,720 (1280×1024). The oscillators 120 may therefore vary the shape of the wavefronts at a rate exceeding the pixel scan rate, such as greater than two times the pixel scan rate, preferably between three and ten times the pixel scan rate. The rate at which the wavefronts vary with time may be a function of all of the oscillators. Accordingly, the oscillators 120 may have individual frequencies lower than the frame rate or pixel scan rate but vary from one another as to phase, frequency, and/or amplitude such that the combined effect of the oscillators 120 is to vary the shape of the wavefront within the scanning time of an individual pixel at a faster rate than either the frame or pixel scan rate. In one embodiment, the oscillators 120 generate a signal of between about 20 and 100 Hz. In another embodiment, the oscillators 120 generate a signal of between about 40 and 80 Hz. In a preferred embodiment, each oscillator 120 generates a signal of about 60 Hz. The peak voltage induced by the oscillators is preferably between two and five volts.

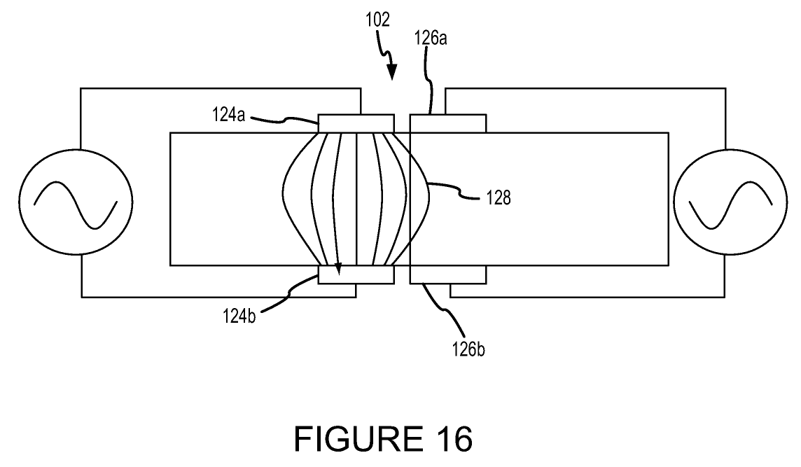

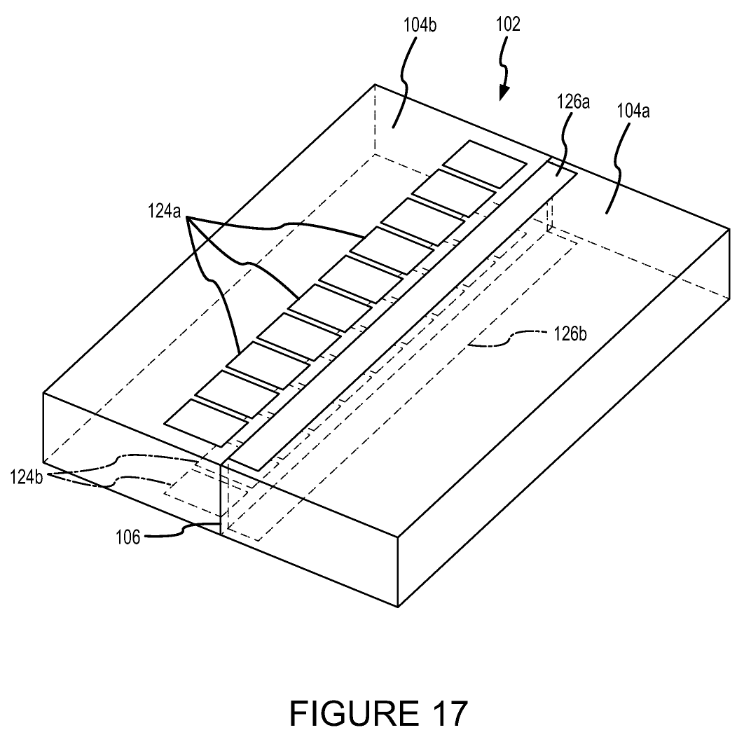

Referring to FIGS. 16 and 17, in an alternative embodiment, the wafer 102 includes first and second sets of electrodes 124a, 124b and 126a, 126b. The electrodes 124a, 124b are located on the first region 104a proximate the domain boundary 106. The electrodes 126a, 126b are located on the second region 104b. The illustrated embodiment includes a single electrode 126a and a single electrode 126b each extending along substantially the entire length of the domain boundary 106. Multiple electrodes 124a and multiple electrodes 124b are positioned on the first region 104a spaced apart from one another along the domain boundary 106.

One or both of the electrodes 126a, 126b are driven at voltages and frequencies effective to modulate light passing therethrough. For example, one or both of the electrodes 126a, 126b may be driven to modulate one or more of the phase, amplitude, and frequency of light passing therethrough. However, the electrodes 124a, 124b are driven at voltages and frequencies effective to cause local time-varying phase-shifted regions in wavefronts of light passing therethrough in order to reduce the visible effect of speckle patterns.

One or both of the electrodes 126a, 126b may, for example, be driven by signal having a maximum voltage between 50 and 100 volts in order to steer a beam passing through the wafer 102 or to modulate the intensity of light exiting the wafer 102. In contrast, the electrodes 126a may be driven by signals having a maximum voltage between two and five volts.

The electric field 128 between the electrodes 126a, 126b curved such that the index of refraction of the wafer 102 will not be constant in the plane of a wavefront. Accordingly, the wavefront will be locally phase shifted as it passes through the electric field 128, notwithstanding the lower voltage applied to the electrodes 126a, 126b.

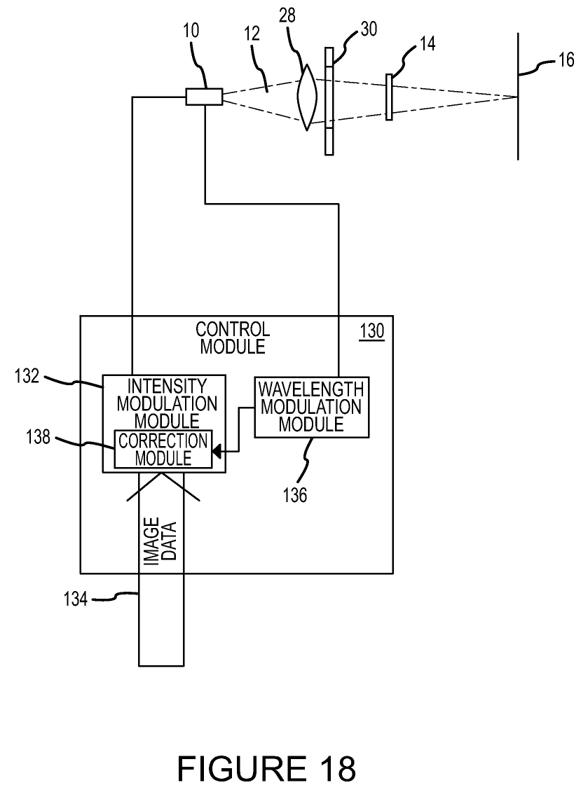

Referring to FIG. 18, in an alternative embodiment, a laser 10 is embodied as a distributed Bragg reflector (DBR) laser having a wavelength distribution that is tunable by changing the temperature of the laser 10. In such embodiments, the wavelength distribution of the laser 10 may be modulated for successive images during display of video data. Inasmuch as the speckle pattern is a function of the wavelength and the surface irregularities on a viewing screen 16, varying the wavelength distribution will cause the speckle pattern to vary. Varying the speckle pattern from frame to frame helps reduce the visible effect of the speckle pattern as successive images are time averaged by a viewer's eye.

The laser 10 is coupled to a control module 130 for controlling the intensity of the laser 10 in order to generate an image. The control module 130 may include an intensity modulation module 132 that determines drive voltage for driving the laser 10 in order to create an image. The intensity modulation module may receive image data 134 corresponding to an image to be displayed and interpret the image data 134 to generate a drive signal for inputting to the laser 10.

In the illustrated embodiment, the control module 130 further includes a wavelength modulation module 136 coupled to the laser 10. Where the laser 10 is a DBR laser the wavelength modulation module 136 may be separately coupled to the laser 10 to modulate the temperature of the laser 10 and thereby affect its wavelength. The wavelength modulation module 136 may be coupled to an intensity correction module 138 within the intensity modulation module 132 such that the intensity modulation module 132 may compensate for perceived variations in intensity caused by variation in the wavelength of the beam 12. The sensitivity of the eye is wavelength dependent and therefore shifts in the wavelength distribution of the laser 10 may be perceived as shifts in intensity. Accordingly, the intensity modulation module 132 may be programmed to use information from the wavelength modulation module 136 to compensate for this effect. In some embodiments, variation in wavelength are measured and corrected according to methods for compensating for variation in wavelength described in U.S. patent application Ser. No. 10/933,003, filed Sep. 2, 2004, which is hereby incorporated by reference.

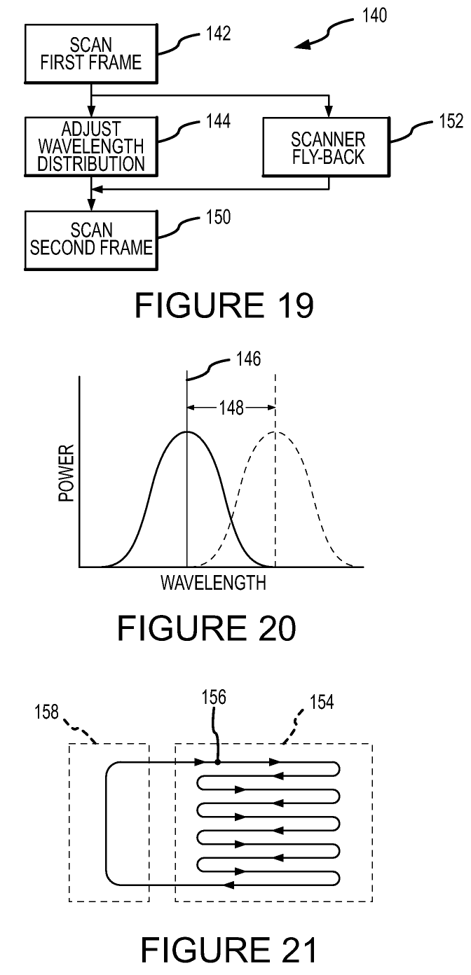

Referring to FIG. 19, a method 140 for reducing apparent speckle may include scanning a first frame using a first wavelength distribution at block 142. The wavelength distribution of the laser 10 is then adjusted at block 144. For example, as shown in FIG. 19, the laser 10 may have a Gaussian spectral power distribution with a mean wavelength 146. Block 44 may therefore include shifting the mean wavelength 146 an amount 148. The amount 148 may be chosen randomly, according to a periodic function, or chosen from a table of discrete values. In some embodiments, the amount 148 is chosen such that the variation in wavelength between each frame differs by a certain minimum amount to achieve appropriate level of speckle reduction. The amount 148 may also be chosen such that the mean wavelength 146 remains within a bounded range of wavelengths. At block 150, a second frame is scanned with the laser 10 producing a beam 12 having the adjusted wavelength distribution. The method 140 may be repeated for multiple successive frames.

In some embodiments of the method 140, the step of adjusting the wavelength distribution of the laser 10 occurs simultaneously with the fly-back period of the scanner 14 at block 152. Referring to FIG. 21, the scanner 14 may scan an image within a viewing area 154 by scanning a beam across the screen as illustrated. After drawing a first image, the scanner 14 returns to an initial position such that the beam reflected from the scanner 14 is directed at point 156. During this period the beam may be directed at a non-viewable area 158 or may be turned off. While the scanner 14 is returning to the initial position 156 preparatory to rendering a subsequent image, the wavelength distribution of the laser 10 may be shifted according to step 152 of the method 140.

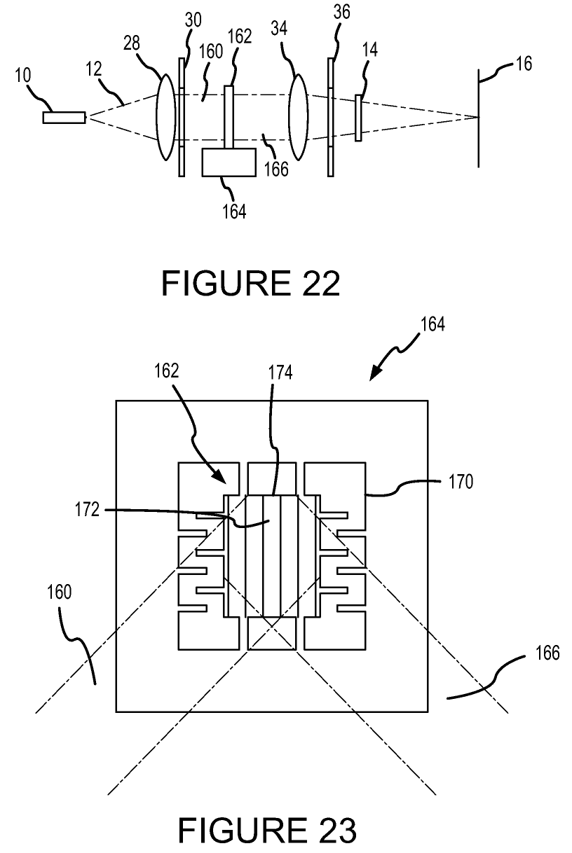

Referring to FIG. 22, in an alternative embodiment, the beam 12 is collimated by the lens 28 to create a collimated beam 160. The collimated beam 160 is incident on a diffractive optical element (DOE) 162. The DOE 162 is mounted to an actuator 164 that moves the DOE 162 such that the diffraction pattern of the beam 166 emitting from the DOE 162 varies with time. The emitted beam 166 is focused by the lens 30 onto the scanner 14. The time varying diffraction pattern of the beam 166 causes the speckle pattern generated on the screen 16 to vary with time. The shifting speckle pattern is time averaged by the viewer's eye such that the visible effect of the speckle pattern is reduced.

The DOE 162 may be embodied as a surface relief diffuser, scattering grain screen, volume hologram, volume hologram in combination with a scattering grain screen, or a multimode fiber. The DOE 162 may also be embodied as an exit pupil expander (EPE), periodic grating such as a multi-lens array (MLA), dual multi-lens array (DMLA), or holographic optical element (HOE).

The scanner 14 of the embodiment of FIG. 22, or of any of the foregoing embodiments, may be a MEMS scanner. For example, the scanner 14 of any of the embodiments disclosed herein may be embodied by any of the scanners described in U.S. Pat. No. 7,071,594, issued Jul. 4, 2006 and entitled MEMS SCANNER WITH DUAL MAGNETIC AND CAPACITIVE DRIVE, which is hereby incorporated by reference. The DOE 162 may likewise be fabricated on the MEMS scale. For example the DOE 162 may have a diameter of less than 3 mm. In other embodiments, the DOE 162 has a diameter of less than 1.5 mm. The scanner 14 may also have a diameter of less than 3 mm in some embodiments or a diameter of less than 1.5 mm in other embodiments.

Referring to FIG. 23, the actuator 164 may be a MEMS scale or conventional scale motor. The actuator 164 may oscillate the DOE 162 translationally or rotationally. For example, the actuator 164 may be embodied as a comb drive 170 having the DOE 162, such as a diffraction grating 172, mounted on, or formed in, an oscillating element 174. In the illustrated embodiment, light reflects from the DOE 162. In an alternative embodiment, the oscillating element 174 is formed of a transmissive material, such as glass, such that light passes through the DOE 162 to the scanner 14.

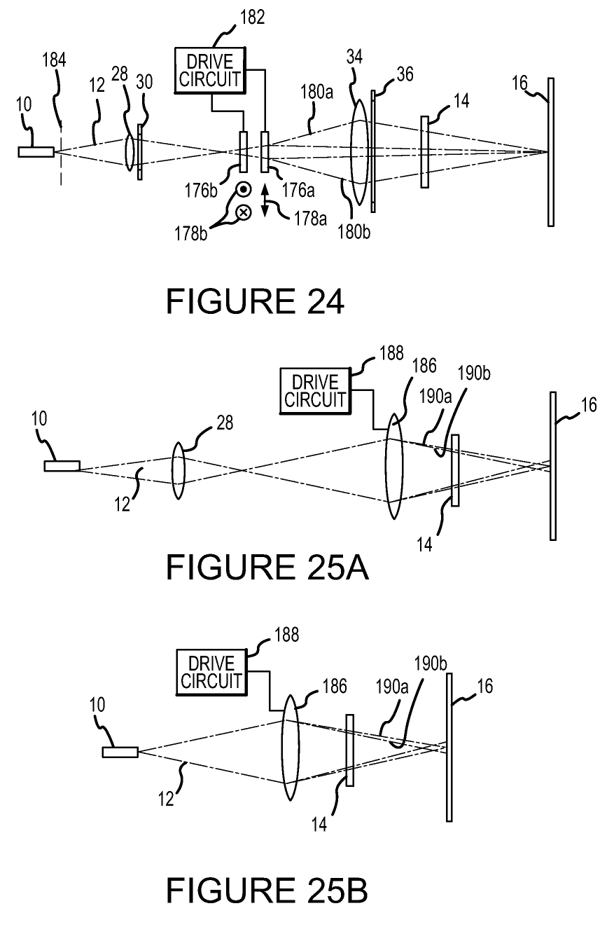

Referring to FIG. 24, in another alternative embodiment, the angle of incidence of a beam on the scanner 14 is modulated at a frequency effective to vary the speckle pattern at the screen 16 such that the speckle apparent to a human viewer is reduced. In the illustrated embodiment, an electro-optical (EO) angular deflector 176a is positioned between the laser 10 and the scanner 14. The angular deflector 176a receives the beam 12 and sweeps an output beam along the direction 178a between positions shown by beams 180a and 180b. In some embodiments a second angular deflector 176b positioned on either side of the angular deflector 176a sweeps the output beam along a direction 178b orthogonal to the direction 176a. The angular deflectors 176a, 176b may deflect the output beam between about 0.5 and five degrees, preferably between about 0.5 and two degrees. The amount of deflection per cycle may be either constant or time varying.

In some embodiments, a drive circuit 182 is electrically coupled to the angular deflectors 176a, 176b and drives them at a frequency that exceeds a frame rate at which the scanner 14 is driven. The scanner 14 may scan a complete image on the screen at a fixed frame rate that may be between about 50 and about 80 Hz, preferably between about 50 and about 70 Hz, and more preferably about 60 Hz. The drive circuit 182 may therefore vary the angle of the beam output from the angular deflectors 176a, 176b at a frequency greater than the frame rate, such as greater than two times the frame rate, preferably between three and ten times the frame rate. The scanner 14 may also be operated to scan pixels onto the screen at a pixel scan rate that is equal to the frame rate multiplied by the number of pixels in the image, such as 307,200 (640×480), 480,000 (800×600), 786,432 (1024×768), or 1,310,720 (1280×1024). The drive circuit 182 may therefore vary the angle of the beam output from the angular deflectors 176a, 176b at a rate exceeding the pixel scan rate, such as greater than two times the pixel scan rate, preferably between three and ten times the pixel scan rate.

The rate at which the beam output from the angular deflectors 176a, 176b varies may be a function the driven frequency of both of the angular deflectors 176a, 176b. Accordingly, the angular deflectors 176a, 176b may each be driven at a frequency lower than the frame rate or pixel scan rate but vary from one another as to phase, frequency, and/or amplitude such that the combined effect of the angular deflectors 176a, 176b is to vary the angle of the output of the angular deflectors 176a, 176b at a rate exceeding either the frame rate or the pixel scan rate.

In the embodiment of FIG. 24, the scanner 14 preferably has a ΘD value sufficiently large that the beams 180a, 180b may be incident on the scanner 14 at different locations such that for a given scanner angle, the beams 180a, 180b can be incident on about the same spot on the screen 16, thereby enabling the same pixel to be illuminated from different angles of incidence to achieve a time varying speckle pattern.

In an alternative to the illustrated embodiment, one or more angular deflectors 176a, 176b may be placed at location 184 proximate the laser 10 rather than at the illustrated location. In yet another alternative embodiment, the angular deflectors 176a, 176b are replaced by one or more rotating wedges slightly deflecting the beam 12, such as between about 0.5 and five degrees, preferably between about 0.5 and two degrees, from the propagation direction of the beam 12.

Referring to FIGS. 25A and 25B, in another alternative embodiment, the beam 12 is incident on a lens 186 having an electrically modulated numerical aperture. The lens 186 is driven by a drive circuit 188. The lens 186 may be adjusted by the drive circuit 188 to change the numerical aperture of the beam emitted by the lens 186, as shown by the beams 190a, 190b. The scanner 14 preferably has a ΘD value sufficiently large to display a range of numerical apertures. The differing numerical apertures will vary the focus of the beams incident on the screen 16, thereby varying the speckle pattern and reducing the amount of speckle apparent to a viewer. The drive circuit 188 preferably modulates the numerical aperture of the output beam at a frequency equal or greater than the frame rate at which the scanner 14 is driven, which may be between about 50 and about 80 Hz, preferably between about 50 and about 70 Hz, and more preferably about 60 Hz. In the embodiment of FIG. 25A, the lens 186 is located proximate the laser 10 and transmits the beams 190a, 190b onto the scanner 14. In the embodiment of FIG. 25B, the lens 186 is located at an intermediate imaging plane such that the beam 12 first passes through lens 28 and is then imaged onto the lens 186, which transmits the beams 190a, 190b onto the scanner 14.

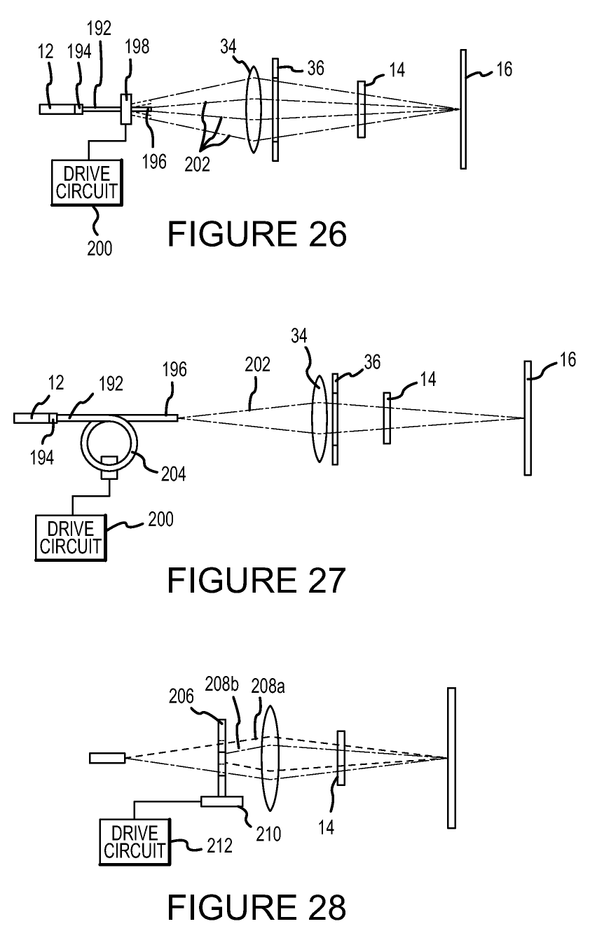

Referring to FIG. 26, in another alternative embodiment, the laser 10 is coupled to an optical fiber 192 by means of an optical coupler 194. The fiber 192 may be either a single- or multimode fiber. An end portion 196 is coupled to an actuator 198 driven by a drive circuit 200. The actuator 198 changes the angle of the end portion 196 and therefore the beam 202 emitted from the fiber 192 such that the angle of incidence of the beam 202 on the screen 16 varies with time, creating a time varying speckle pattern that has a reduced visible effect as compared to a static speckle pattern. The actuator 198 may move the end portion 196 through a range of between about one to 10 degrees, preferably between about one and four degrees. As with other embodiments, the drive circuit 200 may modulate the angle of the end portion 196 at a frequency equal or greater than either the frame rate or pixel scan rate at which the scanner 14 is driven, such as the ranges of frequencies described with respect to the drive circuit 182 of FIG. 24.

Referring to FIG. 27, in another alternative embodiment, the fiber 192 includes a middle portion 204 coupled to the actuator 198 whereas the end portion 196 is fixed. Alternatively, in some embodiments, both the middle portion 204 and end portion 196 are actuated. In the embodiment of FIG. 27, the fiber 192 is preferably a multimode fiber having sufficient length and/or configured such that a substantial number of the modes of the fiber are filled before a beam exits the fiber 192. In the illustrated embodiment, the middle portion is formed as a loop, but other shapes may be used.

The drive circuit 200 modulates the shape of the middle portion 204 to alter the modal structure of the optical path experienced by light passing through the fiber 192. As a result, the beam 202 emitted from the fiber 192 will produce a time varying speckle pattern at the screen 16. As with other embodiments, the drive circuit 200 in the embodiment of FIG. 27 may modulate the angle of the end portion 196 at a frequency equal or greater than either the frame rate or pixel scan rate at which the scanner 14 is driven, such as the ranges of frequencies described with respect to the drive circuit 182 of FIG. 24.

Referring to FIG. 28, in another alternative embodiment, the beam 12 is incident on an aperture 206 that is time varying such that the beams 208a, 208b emitted from the aperture 206 vary as to shape and position. The aperture 206 may be coupled to an actuator 210 coupled to a drive circuit 212 such that the aperture 206 is physically moved into differing positions. Alternatively, the aperture 206 is a liquid crystal (LC) aperture having electrically controlled transparency that provides for adjustment as to size and/or location of the opening through which light is permitted to pass. In such embodiments, the drive circuit 212 may change the size and position of the aperture 206 without physical movement. The scanner 14 in the embodiment of FIG. 28 may preferably have a ΘD value sufficiently large that beams 208a, 208b from different aperture locations and/or sizes can be incident on different locations on the scanner 14 for a given scanner position and yet be focused on the same spot on the screen 16 such that the same pixel may be illuminated at different angles of incidence to create differing speckle patterns. As with other embodiments, the drive circuit 212 in the embodiment of FIG. 28 may modulate the size and/or location of the aperture 206 at a frequency equal or greater than either the frame rate or pixel scan rate at which the scanner 14 is driven such as the ranges of frequencies described with respect to the drive circuit 182 of FIG. 24.

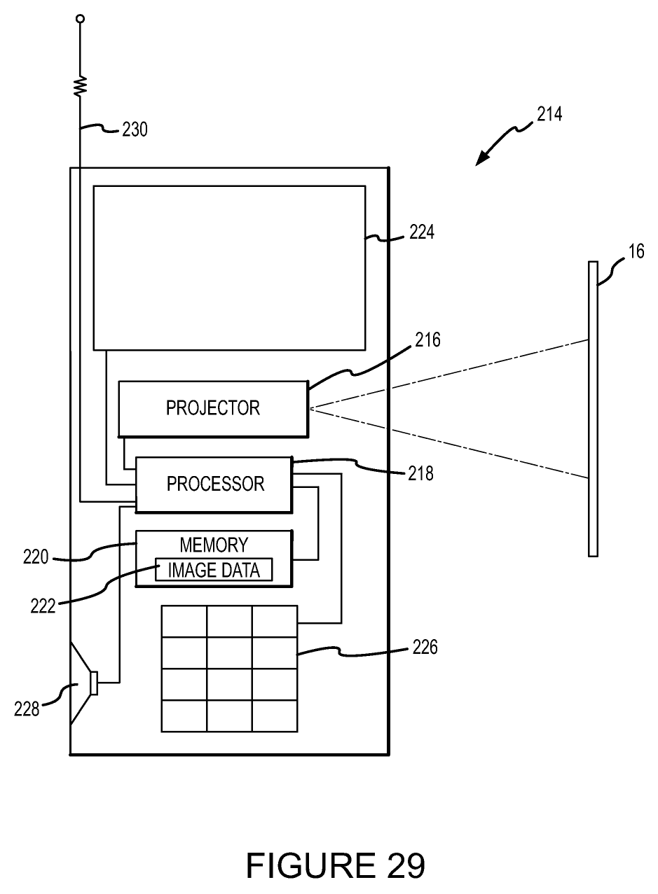

Referring to FIG. 29, any one, or combination of one or more, of the speckle reduction apparatus and methods described above and shown in FIGS. 1-28 may be incorporated into a device 214. The device 214 may include a wireless device cell phone, a portable DVD player, a portable television device, a laptop, a portable e-mail device, a portable music player, a personal digital assistant, or any combination of the same.

The device 214 may include a projector 216 incorporating any one or more of the foregoing speckle reduction apparatus and configured to executed any one or more of the foregoing speckle reduction methods. The projector 216 is coupled to a processor 218 programmed to control the projector, including the laser 10 and the scanner 14 and any actively driven speckle reduction components as described hereinabove. The processor 218 may be coupled to a memory 220 storing image data 222, which may include both still image and video data. The processor 218 may be programmed to process the image data to generate control signals causing the projector 216 to create an image corresponding to the image data 222 on the screen 16. The processor 218 may also be coupled to one or more input and output devices. For example a screen 224, such as an LCD screen 224, may enable a user to view the status of operation of the processor 218 and may serve as an alternative means for displaying the image data 222. In some embodiments, the screen 224 is a touch screen for receiving user inputs. The processor 218 may also be coupled to a keypad 226 for receiving user inputs. A speaker 228 may be coupled to the processor 218 for providing alerts and instructions to a user. The speaker 228 may also present audio data corresponding to video image data 222. An antenna 230 may be coupled to the processor 218 for sending and receiving information. Although the antenna 218 is drawn as extending outside of device, it should be understood that antenna may be housed inside of device and may be positioned anywhere within the device.

Although the invention has been described with reference to the disclosed embodiments, persons skilled in the art will recognize that changes may be made in form and detail without departing from the spirit and scope of the invention. For example, although scanning of the various embodiments have been described with reference to “vertical” and “horizontal” directions, it will be understood that scanning along other orthogonal and non-orthogonal axes may be used instead. Such modifications are well within the skill of those ordinarily skilled in the art. Accordingly, the invention is not limited except as by the appended claims.

What is claimed is:

1. An imaging system comprising:
a coherent light source emitting a first beam;
a scanner comprising a mirror positioned an optical distance from the coherent light source, the mirror having a width greater than an expected width of the first beam projected the optical distance from the coherent light source; and
an optical element interposed between the scanner and coherent light source, the optical element receiving the first beam and emitting a second beam having a numerical aperture substantially larger than the first beam, the second beam being projected onto the mirror.

2. The imaging system of claim 1, wherein the second beam comprises multiple beams.

3. The imaging system of claim 2, wherein the multiple beams overlap.

4. The imaging system of claim 3, wherein the multiple beams are arranged in an ordered array.

5. The imaging system of claim 1, wherein the optical element is an exit pupil expander (EPE).

6. The imaging system of claim 5, wherein the EPE is positioned in a focal plane of the first beam.

7. The imaging system of claim 6, further comprising an image screen, the mirror projecting the second beam onto the image screen.

8. The imaging system of claim 7, wherein the EPE is a two-dimensional array of optical components.

9. The imaging system of claim 1, wherein the optical element comprises multiple light paths each having a distinct optical path length.

10. The imaging system of claim 9, wherein the multiple light paths are arranged in an ordered array.

11. The imaging system of claim 10, wherein the multiple light paths have distinct optical path lengths differing from one another by more than a coherence length of light emitted by the coherent light source.

12. The imaging system of claim 8, further comprising a multi-mode element positioned between the multiple light paths and the scanner.

13. The imaging system of claim 12, wherein the multi-mode element is a delay block.

14. The imaging system of claim 12, wherein the multi-mode element comprises at least two delay blocks.

15. An imaging system comprising:
a coherent light source emitting a first beam;
a scanner comprising a mirror positioned an optical distance from the coherent light source;
an optical element interposed between the scanner and coherent light source, the optical element receiving the first beam and emitting a second beam, the second beam being projected onto the mirror; and
wherein the optical element has a locally electrically modulated index of refraction and wherein the optical element is coupled to one or more drive circuits programmed to exert one or more time-varying voltage signals on the optical element.

16. The imaging system of claim 15, wherein the optical element comprises a lithium niobium oxide (LiNbO₃) wafer.

17. The imaging system of claim 16, wherein the optical element comprises:
inversed and non inversed portions adjoining one another along a domain boundary;
first and second faces parallel to one another and positioned proximate opposite ends of the optical element the first and second parallel faces at a non-perpendicular angle relative to the domain boundary, the first beam being incident on the first face and the second beam emitting from the second face.

18. The imaging system of claim 17, wherein normal vectors of the first and second faces are at an angle between about 4 and about 6 degrees relative to the domain boundary.

19. The imaging system of claim 18, wherein the normal vectors of the first and second faces are at an angle of about 5 degrees relative to the domain boundary.

20. The imaging system of claim 17, further comprising a plurality of electrodes secured to the optical element, each of the electrodes spanning the domain boundary, and wherein the drive circuits are coupled to the electrodes.

21. The imaging system of claim 20, wherein the drive circuits are programmed to exert oscillating signals on the electrodes.

22. The imaging system of claim 21, wherein the scanner has a scan rate and wherein the oscillating signals have a frequency larger than the scan rate.

23. The imaging system of claim 21, wherein the scanner has a scan rate and wherein the oscillating signals are effective to modulate an optical path of the optical element at a frequency substantially larger than the scan rate.

24. The imaging system of claim 23, wherein the scanner comprises horizontal and vertical actuators operable to direct the second beam to form a two dimensional array of pixels at a pixel scan rate, and wherein the oscillating signals are effective to modulate the optical path of the optical element at a frequency larger than the pixel scan rate.

25. A method for improving an image projected from a coherent light source comprising:
emitting a first beam onto a scanner;
actuating the scanner to direct the first beam onto an exit pupil expander (EPE); and
emitting a second beam from the EPE onto an imaging screen, the imaging screen transmitting the second beam to a user's eye, the second beam being substantially more angularly diverse than the first beam.

26. The method of claim 25, wherein the EPE comprises a two dimensional array of optical elements operable to emit the second beam that is substantially more angularly diverse than the first beam.

27. The method of claim 25, wherein the EPE comprises a two dimensional array of diffracting elements and wherein the second beam comprises multiple angularly diverse beamlets.

28. A method for improving an image projected from a coherent light source comprising:
emitting a first beam having a first wavelength distribution from a coherent light source onto a scanner;
actuating the scanner to direct the first beam onto an imaging screen to produce a first image on the imaging screen, the imaging screen reflecting the second beam to a user's eye;
modulating the coherent light source of the coherent light source to emit a second wave length distribution substantially different from the first wavelength distribution; and
emitting a second beam having the second wavelength distribution from the coherent light source onto the imaging screen to produce a second image on the imaging screen, the imaging screen reflecting the second beam to a user's eye.

29. The method of claim 28, wherein the first beam reflects from the imaging screen producing a first speckle pattern and wherein the second beam reflects from the imaging screen producing a second speckle pattern substantially different from the first speckle pattern.

30. The method of claim 29, further comprising modulating an intensity of the second beam substantially effective to compensate for a human perceptible difference between the first wavelength distribution and the second wavelength distribution.

31. The method of claim 29, wherein the coherent light source is a distributed Bragg reflector (DBR) laser.

32. The method of claim 31, wherein modulating the coherent light source to emit a second wavelength distribution comprises tuning a temperature of the DBR laser.

33. The method of claim 32, wherein the step of modulating the coherent light source to emit the second wavelength distribution occurs during a scan fly-back period of the scanner.

34. A method for improving an image projected from a coherent light source comprising:
emitting a beam from a coherent light source onto a scanner;
actuating the scanner to scan the beam across a screen to produce a series of images at a frame rate; and
wherein emitting a beam onto the scanner comprises modulating a wavelength distribution of the beam at a rate equal or greater than the frame rate.

35. The method of claim 34, further comprising modulating an intensity of the second beam substantially effective to compensate for a human perception of modulation of the wavelength distribution.

36. The method of claim 34, wherein the coherent light source is a distributed Bragg reflector (DBR) laser.

37. The method of claim 36, wherein modulating the wave length distribution of the beam comprises a temperature of the DBR laser.

38. The method of claim 34, wherein the step of modulating the wavelength distribution of the beam occurs during a scan fly-back period of the scanner.

39. An imaging system comprising:
a coherent light source emitting a first beam;
a scanner comprising a mirror positioned an optical distance from the coherent light source, the mirror having a width greater than an expected width of the first beam projected the optical distance from the coherent light source; and
an optical element receiving the first beam , the optical element emitting a second beam onto the scanner and modulating angular content of the second beam at a frequency effective to reduce speckle as apparent to a human viewer.

40. The imaging system of claim 39, wherein the optical element is an angular deflector.

41. The imaging system of claim 40, wherein a drive circuit is coupled to the angular deflector, the drive circuit programmed to cause the angular deflector to modulate an angle of the second beam at a frequency equal or greater than a frame rate of the scanner.

42. The imaging system of claim 41, wherein the drive circuit is programmed to cause the angular deflector to modulate the angle of the second beam at a frequency equal or greater than a pixel scan rate of the scanner.

43. The imaging system of claim 41, wherein the angular deflector is a first angular deflector oriented to modulate the angle of the second beam in a first plane, the imaging system further comprising a second angular deflector oriented to modulate the angle of the second beam in a second plane orthogonal to the first plane.

44. The imaging system of claim 39, wherein the optical element comprises a liquid crystal lens coupled to a driver, the driver programmed to modulate the numerical aperture of the liquid crystal lens at a frequency effective to reduce apparent speckle of an image produced by the second beam.

45. The imaging system of claim 39, wherein the optical element comprises an optical fiber having a first end receiving the first beam and a second end emitting the second beam; an actuator coupled to the optical fiber proximate the first end and operable to change an angle of the fiber proximate the first end; and a drive circuit coupled to the actuator, the drive circuit operable to cause the actuator to modulate the angle of the fiber proximate the first end at a frequency effective to reduce apparent speckle of an image produced by the second beam.

46. The imaging system of claim 39, wherein the optical element comprises a multimode optical fiber having a first end receiving the first beam and a second end emitting the second beam; an actuator engaging the optical fiber at a middle portion between the first and second ends and operable to change a shape of the optical fiber between the first and second ends; and a drive circuit coupled to the actuator, the drive circuit operable to cause the actuator to modulate the shape of the optical fiber to an extent and at a frequency effective to reduce apparent speckle of an image produced by the second beam.

47. The imaging system of claim 39, wherein the optical element is a variable aperture modulated as to at least one of size and position at a frequency effective to reduce apparent speckle of an image produced by the second beam.

48. The imaging system of claim 47, wherein the variable aperture is a liquid crystal aperture coupled to a drive circuit operable to modulate the size and position of a transmissive portion of the liquid crystal aperture.

49. A user device, comprising:
a coherent light source emitting a first beam;
a scanner comprising a mirror positioned an optical distance from the coherent light source, the mirror having a width greater than an expected width of the first beam projected the optical distance from the coherent light source; and
an optical element interposed between the scanner and coherent light source, the optical element receiving the first beam and emitting a second beam having a numerical aperture substantially larger than the first beam, the second beam being projected onto the mirror.

50. The user device of claim 49, wherein the user device is a small form-factor device selected from the group consisting of a computing device, a portable device, a wireless device, a cell phone, a portable DVD player, a portable television device, a laptop, a portable e-mail device, a portable music player, and a personal digital assistant.
